(19) United States
(12) Patent Application Publication
(10) Pub. No.: US 2022/0141423 A1
(43) Pub. Date: May 5, 2022

(54) SYSTEMS AND METHODS FOR SWITCHABLE TAILGATE IMAGING AND SENSING

(71) Applicant: Ford Global Technologies, LLC, Dearborn, MI (US)

(72) Inventors: Steven Yellin Schondorf, Dearborn, MI (US); Ahmad Mustapha Nasser, Livonia, MI (US); Ronald Hammond, Brownstown, MI (US); Ed Aziz, Clinton Township, MI (US); Ali Nizar Yassine, Dearborn Heights, MI (US)

(73) Assignee: Ford Global Technologies, LLC, Dearborn, MI (US)

(21) Appl. No.: 17/085,675

(22) Filed: Oct. 30, 2020

(51) Int. Cl. H04N 7/18; B62D 33/027; H04N 5/247

(52) U.S. Cl. CPC H04N 7/18; G01S 15/04; H04N 5/247; B62D 33/0273

(57) ABSTRACT

Switchable tailgate imaging and sensing systems and methods are disclosed herein. A vehicle may include a tailgate comprising a closed position and an open position, a first camera and a second camera configured to obtain images in a field of view, and a first proximity sensor and a second proximity configured to determine a proximity of the vehicle to objects in a sensing area. When the tailgate is in the closed position, the first camera and the first proximity sensor are used. When the tailgate is in the open position, the second camera and the second proximity sensor are used.

### BACKGROUND

Some trucks include proximity sensors incorporated into a rear bumper. A backup camera can also be disposed on the tailgate. When the tailgate is open (i.e., folded in the downward position), the tailgate may obscure a field of view of the proximity sensors. The open position of the tailgate may also reposition the backup camera so that it points towards the ground rather than behind the vehicle.

### BRIEF DESCRIPTION OF THE DRAWINGS

The detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example tailgate in a closed position in accordance with one or more embodiments of the disclosure.

FIG. 2 illustrates an example tailgate in an open position in accordance with one or more embodiments of the disclosure.

FIG. 3 is a schematic diagram of an example switching module for use in systems of the present disclosure in accordance with one or more embodiments of the disclosure.

FIG. 4 is schematic diagram of an example switching module for use in systems of the present disclosure in accordance with one or more embodiments of the disclosure

FIG. 5 is a flowchart of an example method of the present disclosure for switching between cameras and/or proximity sensors based on a current tailgate position in accordance with one or more embodiments of the disclosure.

### DETAILED DESCRIPTION

### Overview

The present disclosure generally pertains to systems and methods where a tailgate is configured with proximity sensors and an additional top-mounted camera. The tailgate can be advantageously deployed on a truck. The proximity sensors can be used to sense tailgate and vehicle proximity to objects when the truck is backing up. The proximity sensors are included on a top or upper end of the tailgate and may be utilized when the tailgate is open (e.g., folded down) and may cover or obscure proximity sensors that are integrated into the back bumper of the truck. The top-mounted camera can be used as a backup camera when another backup camera is re-oriented when the tailgate is down. That is, some trucks may have a backup camera integrated into a handle of the tailgate. When the tailgate is folded down, this first camera may face the ground.

In some instances, the truck can comprise a switching module that switches between cameras and proximity sensors based on a position of the tailgate, either closed or open. Signals from a tailgate sensor can be used to determine a closed or open status of the tailgate. Based on the signal from the tailgate sensor, the switching module can select the camera and proximity sensors to use.

### Illustrative Embodiments

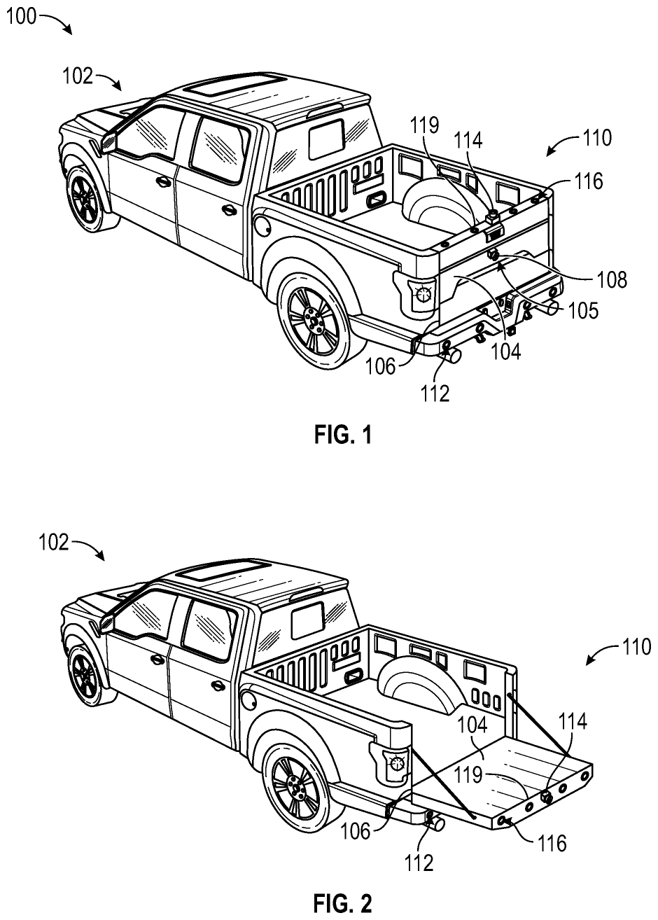

Turning now to the drawings, FIGS. 1 and 2 collectively depict an illustrative architecture in which techniques and structures for providing the systems and methods disclosed herein may be implemented. The architecture 100 can include a truck 102. The truck 102 comprises a tailgate 104 and a rear bumper 106. The tailgate 104 can be referred to generally as a folding mechanism. Thus, while the present disclosure contemplates switching between cameras and proximity sensors based on a current position of a tailgate, the present disclosure is not so limited. The aspects of device switching based on component position can be used for doors, hoods, or other vehicle components in addition to tailgates.

Generally, the tailgate 104 can be opened and closed. For example, the tailgate 104 can be placed in a closed position as illustrated in FIG. 1. The tailgate 104 can be placed in an open position as illustrated in FIG. 2. A user can open the tailgate 104 through actuation of a handle 105.

The truck can include a first camera 108 that is associated with a handle or latch of the tailgate 104. Generally, the first camera 108 is located on an outward facing surface of the tailgate. This first camera 108 can obtain images in a field of view 110 that is directly behind (or adjacent to) a rear outward facing surface of the tailgate 104 of the truck 102. A first set of proximity sensors 112 also obtain proximity signals in a same general area as defined by the field of view 110. Stated otherwise, the first set of proximity sensors 112 can determine proximity of the truck to objects in a sensing area. The sensing area can be coextensive in size with the field of view 110.

The first camera 108 and first set of proximity sensors 112 are selected when the tailgate 104 is in a closed position. In some instances, the first set of proximity sensors 112 includes four sensors, but additional or fewer sensors can be used. The truck can also include a second camera 114 and a second set of proximity sensors 116. As with the first set of proximity sensors 112, the second set of proximity sensors 116 can include four sensors, but additional or fewer sensors can be used.

The second camera 114 and the second set of proximity sensors 116 are placed onto an upper edge 119 of the tailgate 104. Thus, when the tailgate 104 is open or dropped, such as illustrated in FIG. 2, the tailgate 104 obscures the sensing field of the first set of proximity sensors 112. The second set of proximity sensors 116 can be used to sense vehicle and object proximity and the second camera 114 can be used to obtain images in the field of view 110.

In sum, when the tailgate 104 is in the closed position, the first camera 108 and the first set of proximity sensors 112 are used, and wherein when the tailgate 104 is in the open position, the second camera 114 and the second set of proximity sensors 116 are used.

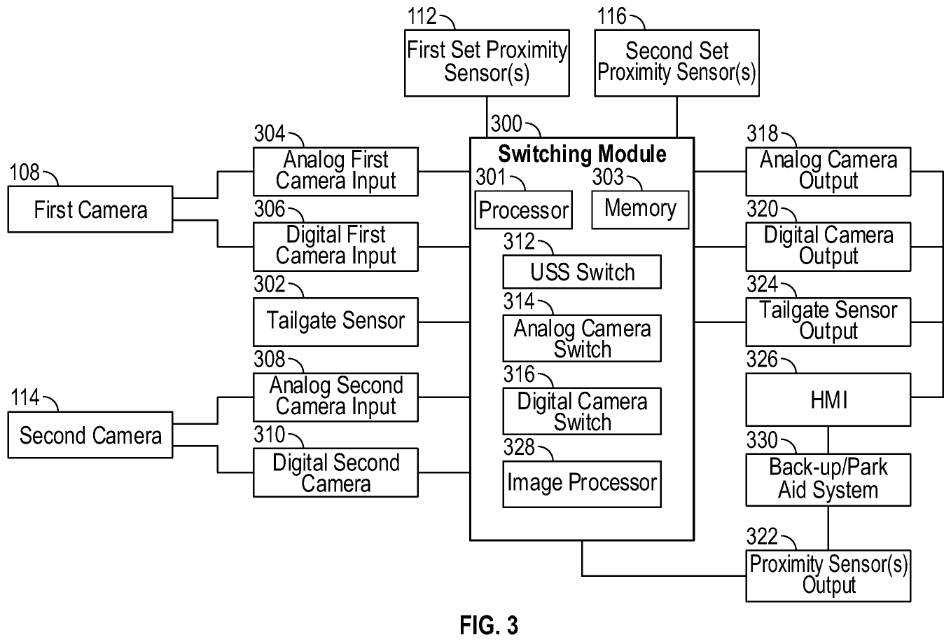

In order to switch between the first and second cameras and the first and second sets of proximity sensors, a switching module 300 can be implemented as illustrated in FIG. 3. FIG. 3 is a schematic representation of an example switching module 300.

The following discussion of FIG. 3 will reference FIGS. 1-3 collectively. Generally, the switching module can comprise a processor 301 and memory 303 for storing executable instructions, the processor 301 can execute instructions stored in memory 303 for performing any of the tailgate signal-based, device switching functionalities disclosed herein. When referring to operations performed by the switching module 300, it will be understood that this includes execution of instructions stored in memory 303 by the processor 301.

The switching module 300 can receive as input, a signal from a tailgate sensor 302. The tailgate sensor 302 is configured to output a signal that indicates if the tailgate 104 is in an open position or a closed position. The switching module 300 also includes inputs from the first camera. For example, the switching module 300 also includes an analog first camera input 304 and a digital first camera input 306. The switching module 300 also includes inputs from the second camera. For example, the switching module 300 also includes an analog second camera input 308 and a digital second camera input 310. Thus, both the first camera and the second camera can output both a digital and an analog signal. To be sure, in some instances, only analog camera input may be used. In other instances, only digital camera input may be used. In some instances, both analog and digital camera input may be used.

The switching module 300 also includes inputs from the first set of proximity sensors 112 and the second set of proximity sensors 116. Based on the signal received from the tailgate sensor 302, an ultrasonic sensor signal (USS) switch 312 can switch between using either the first set of proximity sensors 112 or the second set of proximity sensors 116. When the tailgate sensor 302 outputs a signal that indicates that the tailgate is closed, the USS switch 312 can select to use input from the first set of proximity sensors 112. When the tailgate sensor 302 outputs a signal that indicates that the tailgate is open, the USS switch 312 can select to use input from the first set of proximity sensors 116. The switching module 300 can comprise a proximity sensor output 322. The signals carried on the proximity sensor output 322 are based on the state of the USS switch 312, which can be dictated by tailgate position.

Likewise, when the tailgate sensor 302 outputs a signal that indicates that the tailgate is closed, the USS switch 312 can select to use the digital and analog inputs 304/306 from the first camera 108. When the tailgate sensor 302 outputs a signal that indicates that the tailgate is open, the USS switch 312 can select to use the digital and analog inputs 308/310 from the second camera 114. The switching module 300 can comprise an analog camera switch 314 and digital camera switch 316 that determines which camera feeds are to be used and directed for use through an analog camera output 318 and a digital camera output 320. In some instances, the tailgate signal can also be output to a tailgate sensor output 324. The output of the proximity sensor output 322, the analog camera output 318, and/or the digital camera output 320 can be directed to a user display, such as a human machine interface (HMI 326) or heads up display, for example. In some instances, the output of the proximity sensor output 322 can be coupled with a back-up/park aid system 330 that processes proximity sensor signal output and determines when the vehicle 102 is in proximity to an object. The back-up/park aid system 330 can provide the HMI 326 with data that is indicative of the proximity of the vehicle 102 to an object. This could include, for example, graphically illustrating a distance between the vehicle 102 and the object.

In some instances, if a tailgate sensor is not present, the method could include a step of determining when the tailgate is in an open or closed position based on images received by the respective tailgate cameras. For example, when images obtained from the second camera indicate that the second camera is oriented towards the sky, the tailgate can be determined to be in the closed position. When images obtained from the first camera indicate that the first camera is oriented towards the ground, the tailgate can be determined to be in the open position. The switching module 300 could comprise an image processor 328 that includes a processor and memory. The processor could execute instructions stored in memory to process images using pattern recognition to determine tailgate orientation.

In another example use case, the switching module 300 can determine when the first proximity sensor(s)/parking sensor(s) are blocked by the tailgate. This may include determining when the tailgate is open based on tailgate sensor 302 signals, or from proximity sensor(s)/parking sensor(s) signals directly. In response, the switching module 300 can switch between the first camera and the second camera when determining that the first proximity sensor(s) is/are blocked by the tailgate.

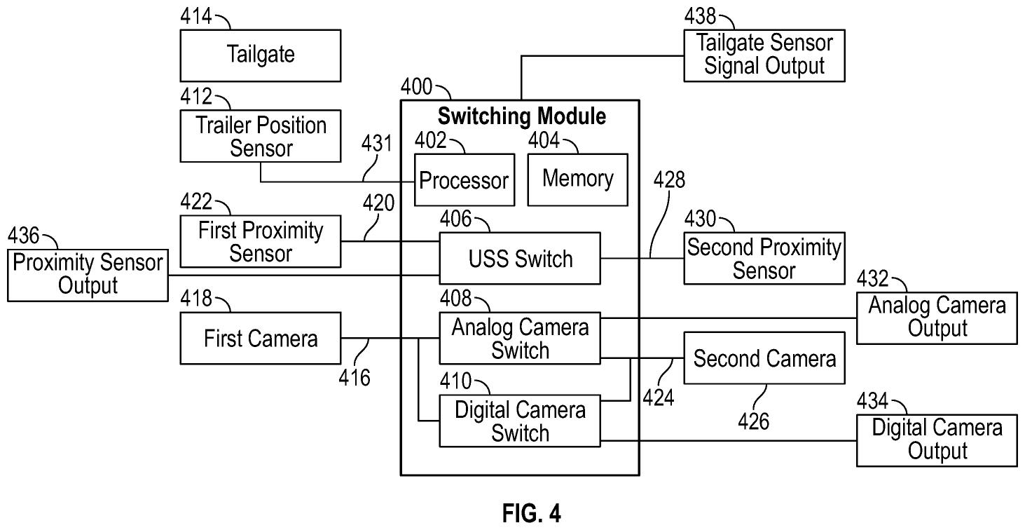

FIG. 4 is a schematic diagram of another example switching module architecture that includes another example switching module 400 of the present disclosure. The following example will reference specific numerical inputs and/or outputs for the switching module 400, which are not intended to be limiting. The switching module 400 can comprise a processor 402, a memory 404, a USS switch 406, an analog camera switch 408, and a digital camera switch 410. The processor 402 can be configured to execute instructions stored in the memory 404 to control the USS switch 406, the analog camera switch 408, and/or the digital camera switch 410 based on input from a trailer position sensor 412. The trailer position sensor 412 may generate a signal based on a current position, either open or closed, of a tailgate 414.

The switching module 400 can comprise a first input 416 that is coupled to a first camera 418 of a truck. As noted above, the first camera can be oriented on a rear outward facing surface of the tailgate 414. The first input 416 can be coupled to the analog camera switch 408 and/or the digital camera switch 410. That is, when the first camera 418 outputs an analog signal, the analog signal is transmitted from the first camera 418 into the switching module 400 through the first input 416 into the analog camera switch 408. If the first camera 418 can output a digital signal, the digital signal is transmitted from the first camera 418 into the switching module 400 through the first input 416 into the digital camera switch 410. In some instances, the first camera 418 could output analog and/or digital data. As noted throughout, the first camera 418 can be configured to obtain images in a field of view behind the truck. In some instances, these images can be output by the first camera 418 analog and/or digital data.

The switching module 400 may comprise a second input 420 that is coupled to a first proximity sensor 422 of the truck. To be sure, the first proximity sensor 422 can be configured to determine proximity of the truck to objects in a sensing area behind the truck. As noted above, the first proximity sensor 422 can be integrated into a body member of the truck, such as a rear bumper.

The switching module 400 can comprise a third input 424 that is coupled to a second camera 426 of the truck. The second camera 426 can be configured to obtain images in the field of view. The second camera 426 can be mounted to an upper edge of the tailgate in some instances. The third input 424 can be directed into the analog camera switch 408 and/or the digital camera switch 410. The second camera 426 can output an analog signal that is transmitted from the second camera 426 into the switching module 400 through the third input 424 into the analog camera switch 408. When the second camera 426 outputs a digital signal, the digital signal is transmitted from the second camera 426 into the switching module 400 through the third input 424 into the digital camera switch 410. The second camera 426 can be configured to obtain images in a field of view behind the truck. In some instances, these images can be output by the second camera 426 analog and/or digital data.

The switching module 400 can comprise a fourth input 428 that can be coupled to a second proximity sensor 430 of the truck. The second proximity sensor 430 can be configured to determine proximity of the truck to objects in the sensing area.

Generally, the switching module 400 can be configured to select the first camera 418 and the first proximity sensor 422 when the signal output by the trailer position sensor 412 indicates that the tailgate 414 is in the closed position, or the second camera 426 and the second proximity sensor 430 when the signal output by the trailer position sensor 412 indicates that the tailgate 414 is in the open position.

In more detail, the USS switch 406 couples to the second input 420 that is associated with the first proximity sensor 422, as well as the fourth input 428 that is associated with the second proximity sensor 430. When the signal output by the trailer position sensor 412 indicates that the tailgate 414 is in the closed position, the USS switch 406 selects the second input 420 of the first proximity sensor 422. When the signal output by the trailer position sensor 412 indicates that the tailgate 414 is in the open position, the USS switch 406 selects the fourth input 428 of the second proximity sensor 430.

The switching module 400 can also be used to select a camera input, which can include either or both analog and digital signals from the first camera 418 and/or the second camera 426. For example, the analog camera switch 408 can couple with both the first input 416 that is coupled to the first camera 418 and the third input 424 that is coupled to the second camera 426. When the signal output by the trailer position sensor 412 indicates that the tailgate 414 is in the closed position, the analog camera switch 408 can select the first input 416. When the signal output by the trailer position sensor 412 indicates that the tailgate 414 is in the open position, the analog camera switch 408 selects the third input 424. Again, the analog camera switch 408 may be used when the first and/or second camera(s) generate an analog signal.

The digital camera switch 410 can couple with both the first input 416 that is coupled to the first camera 418 and the third input 424 that is coupled to the second camera 426. When the signal output by the trailer position sensor 412 indicates that the tailgate 414 is in the closed position, the digital camera switch 410 selects the first input 416. When the signal output by the trailer position sensor 412 indicates that the tailgate 414 is in the open position, the digital camera switch 410 selects the third input 424. Again, the digital camera switch 410 may be used when the first and/or second camera(s) generate a digital signal.

Generally, the switching activities of the USS switch 406, the analog camera switch 408, and the digital camera switch 410 can be controlled by the processor 402 based on the signal received from the trailer position sensor 412. In some instances, the trailer position sensor 412 can be received by the switching module 400 and passed to the processor 402 using a fifth input 431.

The switching module 400 can comprise an analog camera output 432, a digital camera output 434, a proximity sensor output 436, and a tailgate sensor signal output 438. The data transmitted on each of these outputs is based on the switched input signals described above. In general, the analog camera output 432 is coupled to the analog camera switch 408. The digital camera output 434 is coupled to the digital camera switch 410. The proximity sensor output 436 can be coupled to the USS switch 406, and the tailgate sensor signal output 438 can be passed through from the trailer position sensor 412. The proximity sensor output 436 can be output to a back-up/park aid system, as noted above. The analog camera output 432 and the digital camera output 434 can be directed to a HMI or other display of the vehicle.

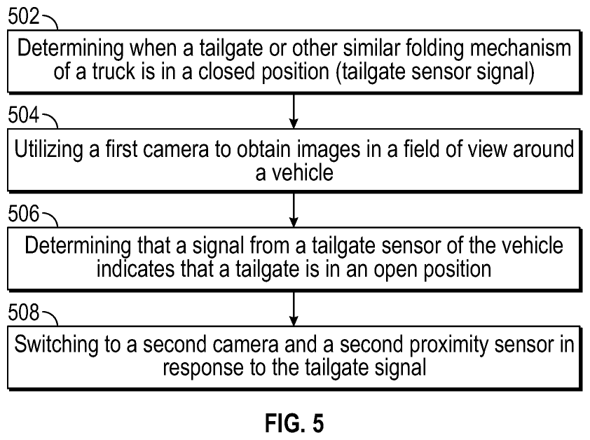

FIG. 5 is a flowchart of an example method that can be performed using a switching module of the present disclosure. The method can include a step 502 of determining when a tailgate or other similar folding mechanism of a truck is in a closed position. As noted, this can include obtaining a signal from a tailgate sensor that is indicative of the tailgate position (e.g., open/closed). When the tailgate position is closed, the method includes a step 504 of utilizing a first camera to obtain images in a field of view around a vehicle. Utilization can include a switching module selecting the first camera as input. Further, when the tailgate position is closed, the method includes a step 504 of utilizing a first proximity sensor (or set of proximity sensors) to determine proximity of the vehicle to an object in a sensing area. The sensing area would include a backup area around the truck.

The method can include a step 506 of determining that a signal from a tailgate sensor of the vehicle indicates that a tailgate is in an open position. To be sure, when the tailgate or other similar folding mechanism is in an open position, the folding mechanism obscures the first parking sensor(s)/proximity sensor(s) and prevents the first camera from obtaining the images in the field of view.

When the tailgate sensor signal indicates that the tailgate is open, the method can include a step 508 of switching to a second camera and a second proximity sensor in response to the tailgate signal. The second camera can be utilized to obtain images in the field of view and the second parking sensor(s)/proximity sensor(s) determines the proximity of the vehicle to objects in the sensing area rather than the first parking sensor(s)/proximity sensor(s).

In various use cases, the method can include a step of switching to the first camera and the first proximity sensor when the signal indicates a closed position of a tailgate of the vehicle. This can include switching a camera input from the second camera to the first camera. For example, a switching module as disclosed herein can have a camera output that connects to a vehicle display. The switching module can select either the first camera to connect to this camera output or the second camera, based on the tailgate position. As noted above, both the first camera and the second camera may obtain images in either or both analog format and digital format.

Implementations of the systems, apparatuses, devices, and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general purpose computer, special purpose computer, or special purpose processing device to perform a certain function or group of functions. An implementation of the devices, systems, and methods disclosed herein may communicate over a computer network. A “network” is defined as one or more data links that enable the transport of electronic data between computer systems and/or modules and/or other electronic devices.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A vehicle, comprising:
a tailgate comprising a closed position and an open position;
a first camera and a second camera disposed about the vehicle; and
a first proximity sensor and a second proximity sensor configured to determine a proximity of the vehicle to objects about the vehicle,
wherein when the tailgate is in the closed position, the first camera and the first proximity sensor are used, and wherein when the tailgate is in the open position, the second camera and the second proximity sensor are used.

2. The vehicle according to claim 1, further comprising a switching module configured to (i) select the first camera and the first proximity sensor for use when the tailgate is in the closed position or (ii) select the second camera and the second proximity sensor for use when the tailgate is in the open position.

3. The vehicle according to claim 1, wherein the vehicle comprises a truck.

4. The vehicle according to claim 1, wherein the first camera is located on a rear outward facing surface of the tailgate when the tailgate is in the closed position, and wherein the second camera is located on an upper edge of the tailgate when the tailgate is in the closed position.

5. The vehicle according to claim 4, wherein the first proximity sensor is associated with a rear bumper of the vehicle.

6. The vehicle according to claim 5, wherein the second proximity sensor is located on the upper edge of the tailgate when the tailgate is in the closed position, and wherein when the tailgate is in the open position, the first camera points towards a ground surface and the second camera points away from a rear of the vehicle.

7. The vehicle according to claim 6, further comprising a tailgate sensor configured to detect if the tailgate is in the open position or the closed position.

8. A switching module for a vehicle, comprising:
a first input coupled to a first camera of the vehicle, wherein the first camera is configured to obtain images in a field of view;
a second input coupled to a first proximity sensor of the vehicle, wherein the first proximity sensor is configured to determine a proximity of the vehicle to objects in a sensing area;
a third input coupled to a second camera of the vehicle, wherein the second camera is configured to obtain images in the field of view;
a fourth input coupled to a second proximity sensor of the vehicle, wherein the second proximity sensor is configured to determine the proximity of the vehicle to objects in the sensing area;
a fifth input configured to receive a signal from a tailgate sensor that detects a position of a tailgate, wherein the signal indicates that the tailgate is in an open position or a closed position; and
a switch configured to select (i) the first camera and the first proximity sensor when the signal indicates that the tailgate is in the closed position or (ii) the second camera and the second proximity sensor when the signal indicates that the tailgate is in the open position.

9. The switching module according to claim 8, wherein the first input includes an analog portion and a digital portion, and wherein the third input includes an analog portion and a digital portion.

10. The switching module according to claim 8, wherein the vehicle comprises a truck.

11. The switching module according to claim 10, wherein the first camera is located on a rear outward facing surface of the tailgate when the tailgate is in the closed position, and wherein the second camera is located on an upper edge of the tailgate when the tailgate is in the closed position.

12. The switching module according to claim 11, wherein the first proximity sensor is associated with a rear bumper of the vehicle.

13. The switching module according to claim 12, wherein the second proximity sensor is located on the upper edge of the tailgate when the tailgate is in the closed position, and wherein when the tailgate is in the open position, the first camera points towards a ground surface.

14. The switching module according to claim 13, wherein the tailgate sensor is configured to detect if the tailgate is in the open position or the closed position.

15. A method, comprising:
determining, by a tailgate sensor, a position of a tailgate of a vehicle;
obtaining, via a first camera and based on the tailgate being in a closed position, an image around the vehicle;
determining, via a first proximity sensor and based on the tailgate being in the closed position, a proximity of the vehicle to an object around the vehicle;
obtaining, via a second camera and based on the tailgate being in an open position, an image around the vehicle; and
determining, via a second proximity sensor and based on the tailgate being in the open position, the proximity of the vehicle to the object around the vehicle.

16. The method according to claim 15, further comprising switching from the first camera and the first proximity sensor to the second camera and the second proximity sensor when the tailgate is moved from the closed position to the open position.

17. The method according to claim 15, wherein the first camera obtains the image in both analog format and digital format.

18. The method according to claim 15, wherein the second camera obtains image in both analog format and digital format.

19. The method according to claim 15, further comprising:
determining that the first proximity sensor is blocked by the tailgate; and
switching, based on the first proximity sensor being blocked by the tailgate, between the first camera and the second camera.

20. The method according to claim 15, further comprising switching, based on the first proximity sensor being blocked by the tailgate, to the second proximity sensor.
